(19) United States
(12) Patent Application Publication
(10) Pub. No.: US 2015/0192257 A1
(43) Pub. Date: Jul. 9, 2015

(54) NARROW-BEAM OPTIC AND LIGHTING SYSTEM USING SAME

(71) Applicant: Cree, Inc., Durham, NC (US)

(72) Inventors: Vachik Javadian, Glendale, CA (US); Megan Tidd, Arvada, CO (US)

(73) Assignee: Cree, Inc., Durham, NC (US)

(21) Appl. No.: 14/148,899

(22) Filed: Jan. 7, 2014

(51) Int. Cl. F21K 99/00; F21V 5/04

(52) U.S. Cl. CPC F21K 9/52; F21V 5/04; F21V 5/045; F21K 9/90; F21Y 2101/02

(57) ABSTRACT

A narrow-beam optic and a lighting system using the optic are disclosed. Embodiments of the present invention provide an optical element, or “optic” that can enable a lighting system to achieve beam control. The optic collects light from substantially all angles of an LED's light output and collimates the light into a narrow beam angle. In example embodiments, the optic includes an entry surface, an exit surface, and a concentrator lens opposite the entry surface and recessed relative to the exit surface. In example embodiments, a mounting feature or spacer adjacent to the entry surface spaces the entry surface and concentrator lens from an LED. An outer surface serves to provide total internal reflection (TIR) and is disposed between the exit surface and the mounting feature.

### BACKGROUND

Light emitting diode (LED) lighting systems are becoming more prevalent as replacements for traditional lighting systems. LEDs are an example of solid state lighting and have advantages over traditional lighting solutions such as incandescent and fluorescent lighting because they use less energy, are more durable, operate longer, can be combined in red-blue-green arrays that can be controlled to deliver virtually any color light, and contain no lead or mercury.

In many applications, one or more LED dies (or chips) are mounted within an LED package or on an LED module, which may make up part of a lighting fixture which includes one or more power supplies to power the LEDs. Some lighting fixtures include multiple LED modules. A module or strip of a fixture includes a packaging material with metal leads (to the LED dies from outside circuits), a protective housing for the LED dies, a heat sink, or a combination of leads, housing and heat sink.

An LED fixture may be made with a form factor that allows it to replace a standard threaded incandescent bulb, or any of various types of fluorescent lamps. LED fixtures and lamps often include some type of optical elements external to the LED modules themselves. Such optical elements may allow for localized mixing of colors, collimate light, and/or provide the minimum beam angle possible.

Optical elements may include reflectors, lenses, or a combination of the two. Reflectors can be, for example, of the metallic or mirrored type, in which light reflects of opaque silvered surfaces. Reflectors may also be made of glass or plastic and function through the principle of total internal reflection (TIR) in which light reflects inside the optical element because it strikes an internal surface of the element at an angle which is equal to or greater than the critical angle relative to the normal vector.

### SUMMARY

Embodiments of the present invention provide an optical element, or “optic” that can enable a lighting system to achieve beam control. The optic combines TIR and other surfaces into one collimator. The optic collects light from substantially all angles of an LED's light output and collimates the light into a narrow beam angle. A lighting system according to example embodiments of the invention can include a single LED and optic, or can include a plurality of LEDs and optics.

An optical element according to at least some embodiments of the invention includes an entry surface and an exit surface. A concentrator lens is disposed opposite the entry surface and the concentrator lens is recessed relative to the exit surface. The concentrator lens may be, as examples, a convex lens or a surface forming, or acting as, a convex lens, or a Fresnel lens. In example embodiments, a mounting feature adjacent to the entry surface spaces the entry surface and concentrator lens from an LED. An outer surface is disposed between the exit surface and the mounting feature. In example embodiments of the invention, the outer surface provides the TIR surface for the optic.

In at least some embodiments, the mounting feature is sized so that the LED would be at a focal point of the concentrator lens and opposite the radial center of the entry surface relative to the concentrator lens. In some embodiments, the mounting feature has a thickness of between 0.5 mm and 1.0 mm. In some embodiments, the mounting feature has a thickness of about 0.75 mm. In some embodiments, the mounting feature is adapted to fit around a submount of an LED device package. In some embodiments, the mounting feature and the entry surface of the optic form an optic-device interface that conforms to the LED device package. In some embodiments, the outer, TIR surface of the optic is at least partially parabolic. In some embodiments, the entry surface has a radius between 1.5 mm and 2.0 mm.

In some embodiments, the base of the recessed, concentrator lens is recessed from about 14 mm to about 18 mm relative to the exit surface, resulting in the exit surface having a flat, annular shape. Thus, a substantially cylindrical wall is formed between the flat, annular exit surface and the base of the concentrator lens. In at least some embodiments, the angle between the exit surface and the substantially cylindrical wall is greater than 90 degrees. In some embodiments of the invention, the angle is about 91 degrees and the base of the concentrator lens is recessed from about 15.5 mm to about 16.0 mm away from a flat, annular exit surface. The concentrator lens can take various forms. As examples the concentrator lens can be or include a convex refracting surface (acting as or being a convex lens) or a Fresnel lens.

A lighting system making use of an optic according to embodiments of the present invention can include at least one LED, and an optical element placed next to an LED so that a center of the LED is at a focal point for the concentrator lens and the optical element receives light from the LED through the entry surface. An electrical connection is provided for the LED or for each of the LEDs if multiple LEDs and optics are used. It should be noted that the mounting feature is located so as not to detract from the luminous area of the optic and in example embodiments does not directly affect the light pattern, but rather, provides appropriate spacing for the other features of the optic. In some embodiments, the mounting feature forms a part of the optical element. In some embodiments, the mounting feature, which may also be referred to herein as a spacer, is fastened to the optical element. This fastening may be accomplished, as an example, through the use of an adhesive. The mounting feature may also be fastened to or rest on an adjacent structure, such as a structure inside a lighting system making use of the optic.

### BRIEF DESCRIPTION OF THE DRAWINGS

FIGS. 1-5 show various perspective views of an optical element according to example embodiments of the present invention.

FIG. 6 presents a detailed, cross-sectional view of the optical element of FIGS. 1-5.

FIG. 7 presents a detailed, cross-sectional view of a portion of an optical element according to additional embodiments of the invention.

FIG. 8 is a close-up view of the entry surface and mounting feature area of an optic according to example embodiments of the invention.

FIG. 9 shows a perspective view of an example lighting system making use of an optic like that illustrated in the foregoing figures.

FIG. 10 shows a view of another example lighting system making use of the optic, according to embodiments of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

The terms “LED” and “LED device” as used herein may refer to any solid state light emitter. The terms “solid state light emitter” or “solid state emitter” may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials. A solid state lighting device produces light (ultraviolet, visible, or infrared) by exciting electrons across the band gap between a conduction band and a valence band of a semiconductor active (light-emitting) layer, with the electron transition generating light at a wavelength that depends on the band gap. Thus, the color (wavelength) of the light emitted by a solid state emitter depends on the materials of the active layers thereof. In various embodiments, solid state light emitters may have peak wavelengths in the visible range and/or be used in combination with lumiphoric materials having peak wavelengths in the visible range. Multiple solid state light emitters and/or multiple lumiphoric materials (i.e., in combination with at least one solid state light emitter) may be used in a single device, such as to produce light perceived as white or near-white in character. In certain embodiments, the aggregated output of multiple solid state light emitters and/or lumiphoric materials may generate warm white light output having a color temperature range of from about 2700K to about 4000K.

Solid state light emitters may be used individually or in combination with one or more lumiphoric materials (e.g., phosphors, scintillators, lumiphoric inks) and/or optical elements to generate light at a peak wavelength, or of at least one desired perceived color (including combinations of colors that may be perceived as white). Inclusion of lumiphoric (also called ‘luminescent’) materials in lighting devices as described herein may be accomplished by direct coating on solid state light emitter, adding such materials to encapsulants, adding such materials to lenses, by embedding or dispersing such materials within lumiphor support elements, and/or coating such materials on lumiphor support elements. Other materials, such as light scattering elements (e.g., particles) and/or index matching materials may be associated with a lumiphor, a lumiphor binding medium, or a lumiphor support element that may be spatially segregated from a solid state emitter.

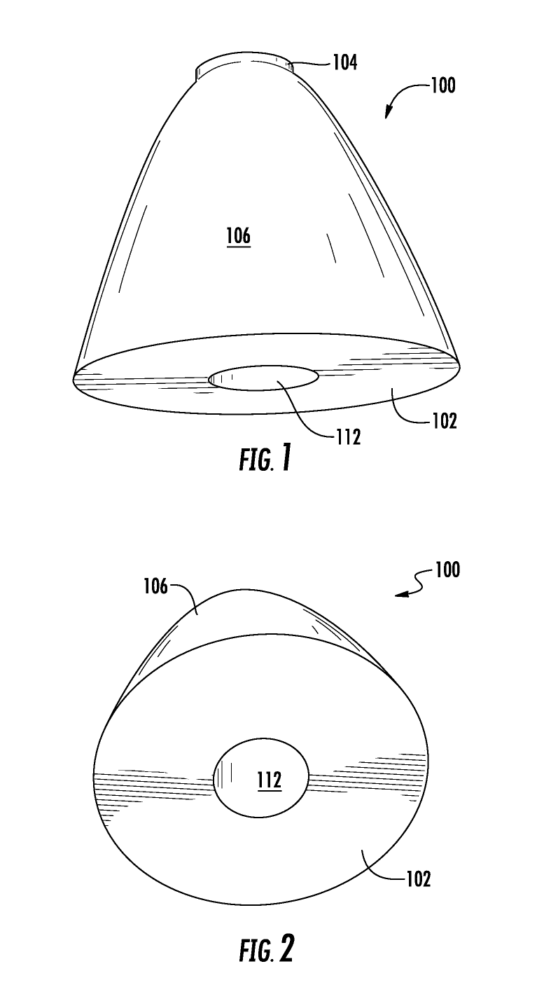

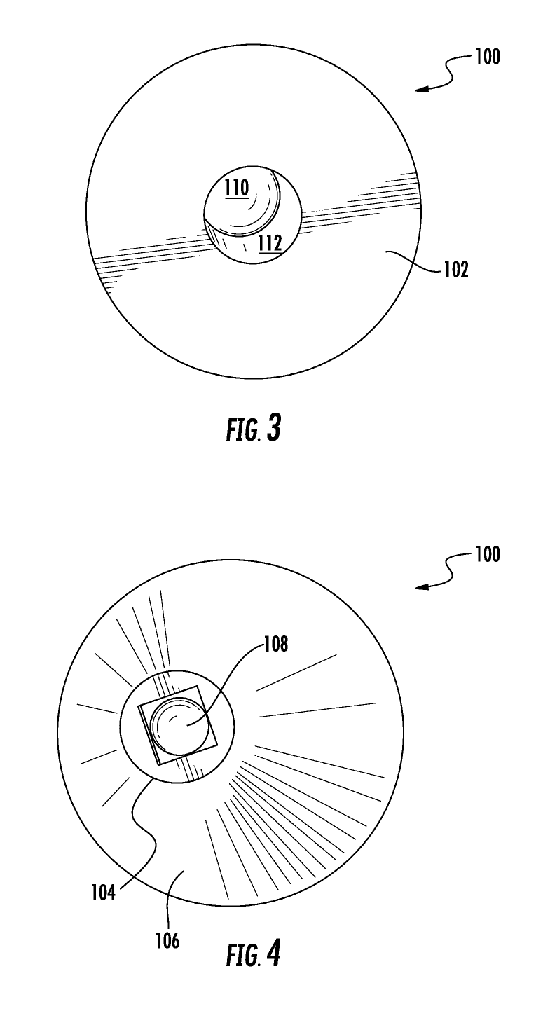

FIGS. 1 through 5 illustrate various perspective views of an optic, 100, according to example embodiments of the present invention. In example embodiments, the optic is substantially made of clear, optical material such as glass or plastic. Such material has an index of refraction of approximately 1.5. The refractive indices of glasses and plastics vary, with some having an index of refraction as low as 1.48 and some having an index of refraction as high as 1.59. Exit surface 102 is visible in FIGS. 1, 2, and 3. In example embodiments, the exit surface is substantially flat. In at least some embodiments, the exit surface is annular in shape due to the recess for the concentrator lens discussed in more detail below. Mounting feature 104 is visible in FIGS. 1, 2, and 5. Disposed between the flat, annular exit surface 102 and the mounting feature 104 is an outer surface 106 that provides the TIR surface for the optical element. Surface 106 is visible in FIG. 1, FIG. 2, FIG. 4, and FIG. 5. Mounting feature 104 serves as a spacer to maintain the various optical surfaces of the optical element at an appropriate distance from an LED light source. Mounting feature 104 may be molded into and form a part of the optic. Alternatively, mounting feature 104 may be a separate component and may or may not be made of a different material than the main portion of optic 100. In such a case, mounting feature 104 might be fastened to the rest of optic 100 with adhesive. The mounting feature can also be attached to or supported by a structure adjacent to the main body of the optic such as a portion of a fixture or lighting system making use of the optic.

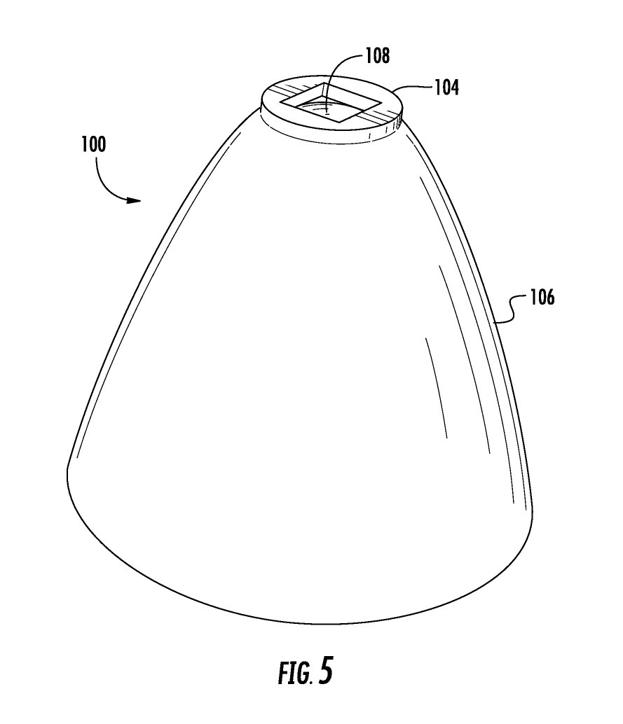

Referring to FIGS. 3, 4, and 5, entry surface 108 is visible in FIG. 4 and FIG. 5, and concentrator lens 110, opposite the entry service 108, is visible in FIG. 3. In this example embodiment, the concentrator lens is a convex, refracting surface that forms a convex lens. Also in this embodiment, the entry surface is a curved entry surface. As can also be seen in FIG. 3, convex refractive surface 110 is recessed relative to flat, annular exit surface 102. In example embodiments, mounting feature 104 is sized so that an LED would be at a focal point of the convex refractive surface 110. Mounting feature 104 may also space curved entry surface 108 appropriately from an LED light source. In example embodiments, the LED light source is opposite the radial center of the curved entry surface 108 from the convex refractive surface, and is the focal point for concentrator lens 110.

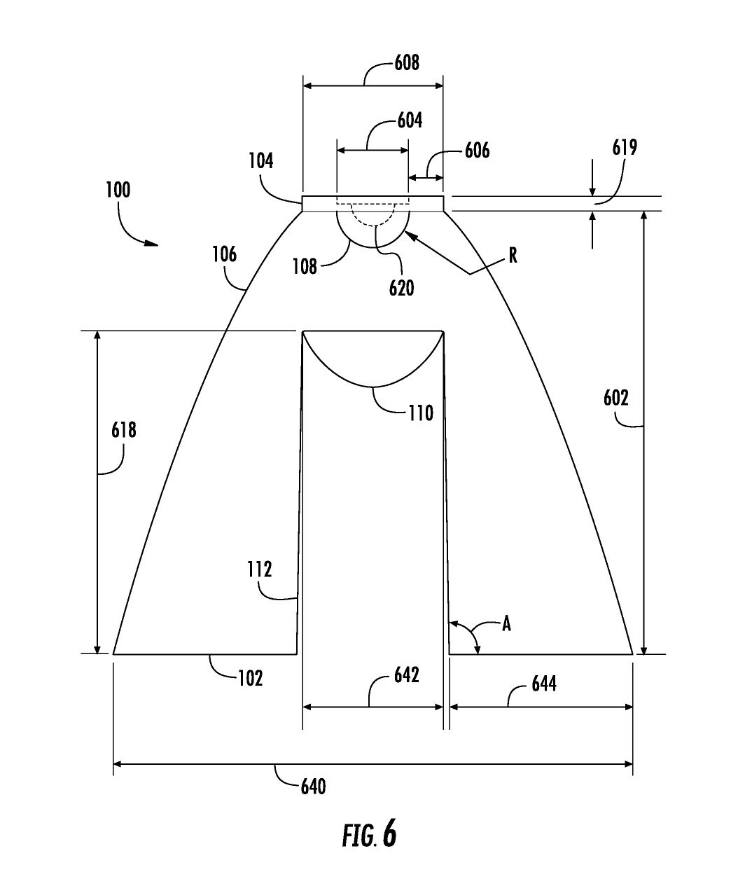

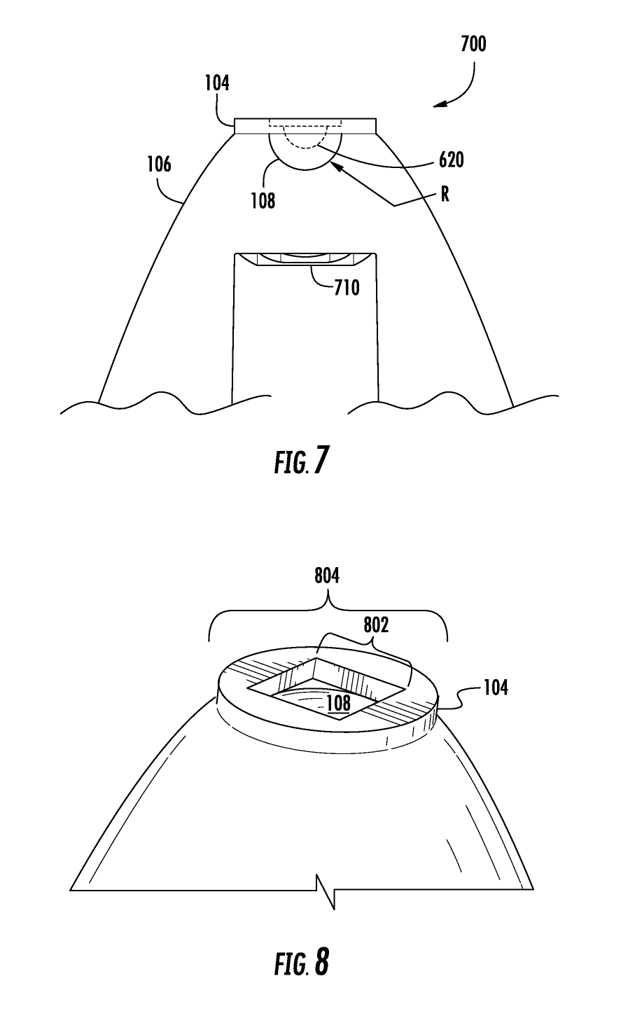

Referring now to FIGS. 1, 2, and 3, the recessed convex refractive surface defines a substantially cylindrical wall 112 between the flat annular exit surface and the base of the convex refractive surface. In at least some embodiments, the angle between the substantially cylindrical wall and the flat, annular exit surface is greater than 90 degrees. Stated differently, the substantially cylindrical surface 112 has a slightly conical shape. The geometric details of this part of the optical element 100 are more apparent in FIG. 6, discussed below.

Turning to FIG. 6, a cross section of optic 100 is shown, with many dimensions indicated by additional reference numbers. In example embodiments, the length 602 of the main body of the optic is between about 16 mm and about 26 mm. In some embodiments, this length is from about 20 mm to about 23 mm. In still additional embodiments, this length is about 21.71 mm. Measurement 602 also specifies the length of the outer surface 106. In at least some embodiments, this surface is at least partially parabolic. A parabolic shape as may be used in at least portions or sections of outer surface 106 is defined by the formula:

$$z = \frac{{cr}^{2}}{1 + \sqrt{1 - ( 1 - {kc}^{2} {r}^{2} )}}$$

where x, y and z are positions on a typical 3-axis system, k is the conic constant, and c is the curvature. The formula specifies conic shapes generally. For a parabolic shape, k is less than or equal to −1. However, it should be noted that the outer surface being or including a surface that is parabolic, and indeed being or including a surface that is conic is just an example. Optical elements could be designed with outer surfaces of various shapes; for example, angled, arced, curved as well as spherical, including segmented shapes.

A parabolic surface or parabolic surfaces as shown in the examples disclosed herein may be used to provide total internal reflection (TIR), however, there may be instances where total internal reflection is not be needed or desired at all points of the optic. In at least some embodiments, the cross-sectional curve of surface 106 may include several parabolic curve sections combined by simulation to maximize the TIR characteristics of the optic.

Still referring to FIG. 6, curved entry surface 108 in example embodiments has a radius R between 1.5 mm and 2.0 mm. In some embodiments, the radius R is about 1.8 mm. The width 604 of the surface can be about 3.6 mm, or range from about 3.0 mm to 4.0 mm. The distance 606 from the edge of the curved entry surface to the edge of the optic when the width of the entry surface is about 3.6 mm, is about 1.64 mm. This distance can vary with the width of the entry surface when the total width 608 of the entry portion of the optic is maintained. In some embodiments width 608 can range from about 6.5 mm to about 7.0 mm. In some embodiments, width 608 is about 6.88 mm. In some embodiments, the base of the concentrator lens 110 is at a distance 618 from flat, annular exit surface 102 of from about 14 mm to about 18 mm. In some embodiments this recess distance can be from about 15.5 mm to about 16.0 mm. In some embodiments, this recess distance is about 15.83 mm. These dimensions, together with the thickness 619 for spacer 104 of from about 0.5 mm to about 1.0 mm, or in some embodiments, about 0.75 mm, keep the optical surfaces of the optical element at an appropriate distance from packaged LED 620. In such embodiments, the LED chip itself is at or near the focal point of concentrator lens 110, and at the other side of the radial center of curved entry surface 108 from the convex refractive surface.

In at least some embodiments, the chip is coated with or packaged with a lumiphor in order to create substantially white light. The emitter package can be referred to herein merely as an “LED” even if it contains more elements than a lone semiconductor die. In at least some systems, the LED chip itself is packaged and fastened to a flat structure that is or is similar to a small circuit board, which provides electrical connections. The LED device lens may also be fixed to this structure, which can be referred to as a “submount.” The submount and lens of the LED device package in FIG. 6 are shown in broken lines.

Continuing with FIG. 6, example dimensions of the exit portions of optic 100 in some embodiments may be as follows. The total width 640 across the flat, annular exit surface in example embodiments can be from about 20 mm to about 30 mm. In some embodiments, this width is from about 25 mm to about 26 mm. In at least some embodiments, the width is about 25.39 mm. The distance 642 across the base of the concentrator lens that is recessed within the optic can be from about 6.5 mm to about 7 mm. In at least some embodiments, this width is from about 6.8 mm to about 6.9 mm, or about 6.85 mm. Cylindrical wall 112 may be perpendicular to the base of concentrator lens 110, in which case the width of the annular part of the exit surface, 644, is just the difference between width 640 and distance 642. However, in some embodiments, angle A is greater than 90°. Thus, the cylindrical shaft formed by the recess of concentrator lens 110 has a “draft” of anywhere from a fraction of a degree to several degrees. In at least some embodiments, angle A is about 91°. In this case, distance 644 across the annular part of the exit surface is about 9 mm. In various embodiments, distance 644 can be anywhere from about 8 mm to about 10 mm, or from about 8.5 mm to about 9.5 mm. If any of the distances shown in FIG. 6 are altered within the example ranges given, adjustments may need to be made to other surfaces and distances in the optic. The size of the optic can also be adjusted to accommodate variations.

The optic works in part because the conic or parabolic outer surface provides for many light rays to be totally reflected internally and exit the optic through the exit surface 102 at or near a normal angle relative to the exit surface. However, since the entry surface is curved and possibly spherical in shape like the light pattern from the LED, light rays are not bent by the entry surface. Light rays which strike outer surface 106 are reflected through exit surface 102 at a normal angle. If the exit surface were contiguous across its diameter, light rays that came from the light source straight up would also exit the optic at a normal angle. However, all other light rays would leave the optical element through the exit surface 102 at an angle and be bent away from the normal vector relative to exit surface 102 if the exit surface were contiguous, since these rays would be passing from a medium with a refractive index of roughly 1.5 into air, which has a refractive index of approximately 1. This bending away would actually decrease the collimation of the light through the optical element. The recessed concentrator lens is provided to collimate these light rays so that substantially all the light leaving the optic is collimated.

In at least some embodiments, the concentrator lens can be molded into the optic, for example where acrylic is used and the entire optic is injection molded. The concentrator lens could also be placed upon a flat recessed surface within the optic and fastened there with adhesive, force fit into the recess, or otherwise mounted by fasteners, tabs, or the like. These latter techniques may be more effective if the concentrator is other than a convex lens surface, such as the Fresnel lens shown in FIG. 7, which illustrates a portion of an optic according to additional embodiments of the invention. Optic 700 includes mostly the same surfaces and features previously discussed, as indicated by like reference characters. However, optic 700 includes Fresnel lens 710 as a concentrator lens in lieu of the convex surface previously shown. The design of a Fresnel lens can vary and other dimensions of the optic may need to be adjusted accordingly.

FIG. 8 shows a detailed view of the mounting feature and entry surface of the optic according to example embodiments. In FIG. 8, it can be observed that mounting feature 104 includes a square aperture defined by four sides 802. In the examples shown herein this aperture is adapted, sized, and/or shaped so that the mounting feature fits around and/or conforms to the submount of the LED device package used. Entry surface 108 then conforms to the lens of the LED package. It can be said that the mounting feature and entry surface together form an optic-device interface 804 that conforms to the LED device package. The shape of the aperture and the entry surface can very to accommodate various types of LED devices and packages. The aperture could be round, oval, rectangular, or irregularly shaped. The entry surface likewise could be cubic, square, triangular, conical, or any other geometric shape needed and could conform to, as examples, an LED package with a hemisphere-shaped lens or a cubic-shaped lens.

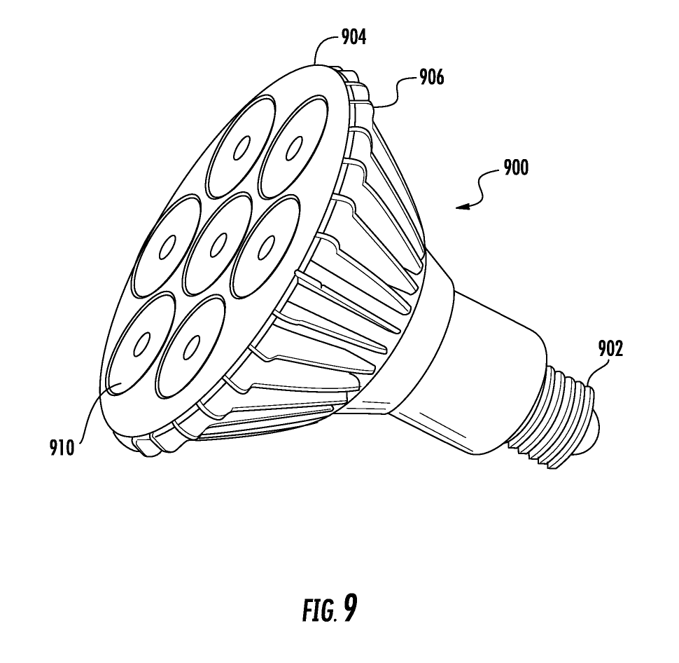

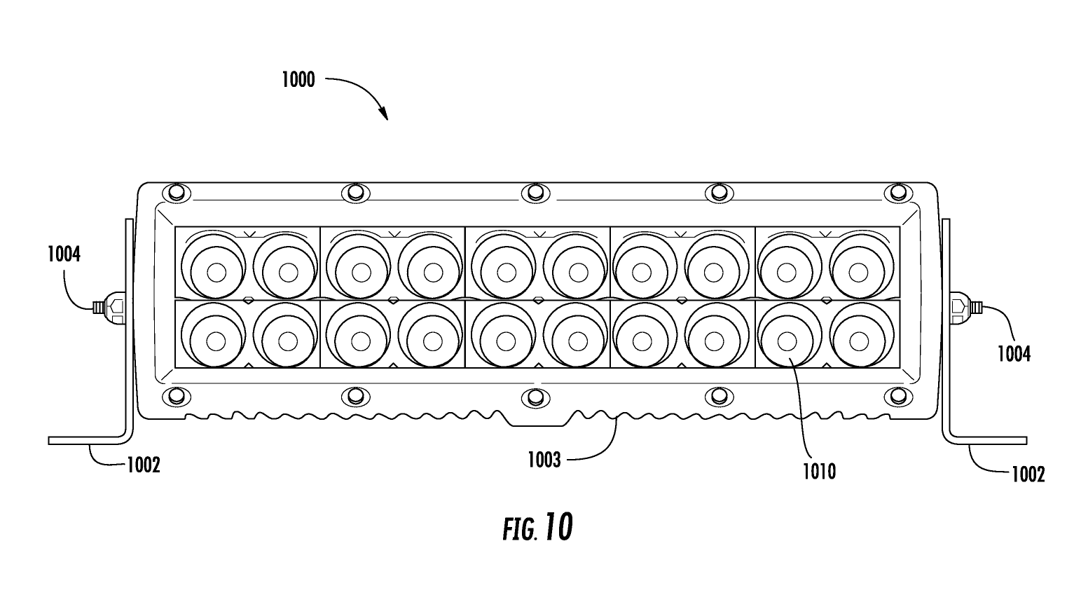

FIG. 9 is an illustration of a lighting system making use of an optical element as described herein. Lighting system 900 is formed to be a replacement for a standard R30 incandescent bulb of the type commonly used in so-called “recessed can” ceiling light fixtures. The lighting system includes a standard threaded base 902, through which is provided an electrical connection for the LED. In the example of FIG. 9, a power supply or driver (not shown) is included within the base of the lighting system so that the system can be function from standard AC line voltage. Seven LEDs are used as the light source and are located inside the lighting system behind front plate 904. Cooling fins 906 aid in maintaining an appropriate operating temperature inside the system. There is a void above each LED module, and the void contains optical element 910, which is an optical element according to example embodiments of the present invention.

FIG. 9 presents just one example of a use of an optical element according to embodiments of the present invention. An individual optic can be used in smaller lighting systems such as those based on an “MR” form factor. The optic can be used in any of various systems that require an AC to DC driver. Additionally, the optic can be used in DC-based systems that do not require AC to DC voltage conversion. Examples of such uses include use in vehicular lighting systems such as off-road vehicles, trucks, cars, boats and marine vehicles, agricultural vehicles, military vehicles, ATV/UTV dirt bikes, mining vehicles, fire and rescue vehicles, etc., as well as in compact, battery-operated systems such as flashlights.

FIG. 10 is an illustration of another example lighting system making use of optical elements as described herein. Lighting system 1000 is a so called, “light bar” for a vehicle. The lighting system includes mounting brackets 1002 to which the housing 1003 is fastened with bolts 1004. Lighting system 1000 includes built-in circuitry (not shown) to drive the LEDs. In this case, the power supplied is vehicular DC power so that the circuitry does not need to provide AC to DC conversion. Twenty LEDs are used as the light source and are located inside the lighting system behind optical elements 1010, which are similar to or the same as the optic shown in FIGS. 1-6. The optical elements and corresponding light sources are arranged in two rows of ten. However, any other arrangement is possible with many different numbers of light sources and optics. A light bar or light panel like that of FIG. 10 can also include an AC to DC power supply or driver, a standard AC line cord, and a stand or bracket so that the lighting system can serve more appropriately as a task light or work light.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. An optical element for a lighting system, the optical element comprising:
an entry surface;
an exit surface;
a concentrator lens opposite the entry surface, the concentrator lens being recessed relative to the exit surface;
a mounting feature adjacent to the entry surface to space the entry surface and concentrator lens from an LED; and
an outer surface disposed between the exit surface and the mounting feature.

2. The optical element of claim 1 wherein the concentrator lens further comprises at least one of a convex refractive surface and a Fresnel lens.

3. The optical element of claim 2 wherein the mounting feature is sized so that the LED would be at a focal point of the concentrator lens and opposite the radial center of the entry surface relative to the concentrator lens when the optical element is in use.

4. The optical element of claim 3 wherein the mounting feature is adapted to fit around a submount of an LED device package.

5. The optical element of claim 4 wherein the mounting feature and the entry surface form an optic-device interface that conforms to the LED device package.

6. The optical element of claim 3 wherein the mounting feature has a thickness of between 0.5 mm and 1.0 mm.

7. The optical element of claim 6 wherein the outer surface is at least partially parabolic.

8. The optical element of claim 7 wherein the entry surface has a radius between 1.5 mm and 2.0 mm.

9. The optical element of claim 8 wherein a base of the concentrator lens is recessed from about 14 mm to about 18 mm relative to the exit surface, forming a substantially cylindrical wall between the exit surface and the base of the concentrator lens.

10. The optical element of claim 9 wherein the angle between the exit surface and the substantially cylindrical wall is greater than 90 degrees.

11. The optical element of claim 10 wherein the mounting feature has a thickness of about 0.75 mm.

12. The optical element of claim 11 wherein the angle between the exit surface and the substantially cylindrical wall is about 91 degrees and base of the concentrator lens is recessed from about 15.5 mm to about 16.0 mm.

13. A lighting system comprising:
at least one LED; and
at least one optical element further comprising;
an entry surface;
an exit surface;
a concentrator lens opposite the entry surface, the concentrator lens being recessed relative to the exit surface;
a mounting feature adjacent to the entry surface to space the entry surface and concentrator lens from the LED so that a center of the LED is at a focal point for the concentrator lens; and
an outer surface disposed between the exit surface and the mounting feature.

14. The lighting system of claim 13 wherein the concentrator lens further comprises at least one of a convex refractive surface and a Fresnel lens.

15. The lighting system of claim 14 comprising an LED device package for the LED and wherein the mounting feature is adapted to fit around a submount of an LED device package.

16. The lighting system of claim 15 wherein the mounting feature and the entry surface form an optic-device interface that conforms to the LED device package.

17. The lighting system of claim 16 wherein the mounting feature has a thickness of between 0.5 mm and 1.0 mm.

18. The lighting system of claim 13 wherein the outer surface is at least partially parabolic.

19. The lighting system of claim 18 wherein the entry surface has a radius between 1.5 mm and 2.0 mm.

20. The lighting system of claim 19 wherein a base of the concentrator lens is recessed from about 14 mm to about 18 mm relative to the exit surface, forming a substantially cylindrical wall between the exit surface and the base of the concentrator lens.

21. The lighting system of claim 20 wherein the angle between the exit surface and the substantially cylindrical wall is greater than 90 degrees.

22. The lighting system of claim 21 comprising a plurality of the LEDs and a plurality of the optical elements arranged so that each optical element directs light from one of the plurality of LEDs.

23. The lighting system of claim 21 wherein the mounting feature has a thickness of about 0.75 mm.

24. The lighting system of claim 23 wherein the angle between the exit surface and the substantially cylindrical wall is about 91 degrees and the base of the concentrator lens is recessed from about 15.5 mm to about 16.0 mm.

25. A method of assembling a lighting system, the method comprising:
positioning at least one LED device package including an LED;
placing at least one optical element at an LED device package, spaced from the LED device package so that a center of the LED is at a focal point for a concentrator lens and the optical element receives light from the LED through an entry surface, the optical element further comprising an exit surface wherein the concentrator lens is recessed relative to the exit surface and an outer surface is disposed between the exit surface and the entry surface;
providing an electrical connection for the at least one LED.

26. The method of claim 25 wherein the placing of the at least one optical element further comprises placing the optical element with a mounting feature to position the concentrator lens and the entry surface relative to the LED.

27. The method of claim 26 wherein the mounting feature forms a part of the optical element.

28. The method of claim 27 wherein the mounting feature is adapted to fit around a submount of the LED device package.

29. The method of claim 28 wherein the mounting feature and the entry surface form an optic-device interface that conforms to the LED device package.

30. The method of claim 26 wherein the wherein the placing of the at least one optical element on the mounting feature further comprises fastening the mounting feature to the optical element.

31. The method of claim 26 wherein the mounting feature has a thickness of between 0.5 mm and 1.0 mm.

32. The method of claim 31 wherein the fastening the mounting feature to the optical element further comprises fastening the mounting feature to the optical element using an adhesive.

33. The method of claim 32 wherein the concentrator lens further comprises a convex refractive surface.

34. The method of claim 32 wherein the concentrator lens further comprises a Fresnel lens.
